(19) United States
(12) Patent Application Publication
(10) Pub. No.: US 2008/0060206 A1
(43) Pub. Date: Mar. 13, 2008

(54) Hygienic utensil

(76) Inventor: Ronald D. DeSalvo, Peoria, AZ (US)

Correspondence Address: GALLAGHER & KENNEDY, P. A., 2575 E. CAMELBACK RD. #1100, PHOENIX, AZ, 85016, US

(21) Appl. No.: 11/821,138

(22) Filed: Jun. 21, 2007

Related U.S. Application Data
(60) Provisional application No. 60/825,092, filed on Sep. 8, 2006.

(51) Int. Cl. A47J 43/28

(52) U.S. Cl. 30/327

(57) ABSTRACT

There is provided a utensil such as a spoon, knife, or fork adapted for hygienic usage. The utensil includes a stem portion where a user's hand would typically grasp the utensil and a food manipulating portion. A hook is disposed on the utensil stem. In one embodiment, the utensil is a spoon for use with baby food jars. The hook is formed from the same material as the spoon. The hook allows a user to rest the spoon on the rim of the baby food jar so as to position the bowl of the spoon near the bottom of the baby food jar, a position that is the most position to rest a spoon when not in use for purposes of hygiene.

### CROSS REFERENCE TO RELATED APPLICATIONS

This application claims priority from the provisional patent application Serial No. 60/825,092 filed Sep. 8, 2006 in the name of Ronald D. DeSalvo entitled “Spoon with Built On Rim Hook.” This application is also related to PCT application Ser. No. ______, entitled “Hygienic Utensil” in the name of Ronald D. DeSalvo, filed concurrently herewith.

### FIELD OF THE INVENTION

The present invention relates to utensils. More particularly, the invention relates to utensils such as spoons and forks with hooks for positioning the utensil so as to avoid contamination as well as maintain the handle in a convenient position for the user to grasp.

### BACKGROUND OF THE INVENTION

Eating utensils such as spoons, forks, and knives share common design features. The utensils have a stem that consists of a handle by which the user grasps the utensil and an unused portion that provides structure and length. Connected to the distal end of the stem is a functioning portion shaped for manipulating or storing food. Under current designs, utensils are typically stored, when not in use, by laying them on a surface. Thus, for example, it is familiar to position a place setting of knife, spoon, and fork by resting them on the table surface.

While this design may be satisfactory for many users, there are some users who would prefer to have an improved design that enhances the hygienic performance and function of a utensil. For example, many users object to using a utensil after that utensil has come into contact with an unsanitary surface. As a first example, users may object to the reuse of a spoon in the following circumstances. A spoon may be first applied to a food container, such as a coffee mug or a bowl, and the spoon may then by necessity be placed in contact with an unsanitary surface, such as a table top, counter, shelf, or the like. Later, the user may desire to reuse the spoon. However, the user may be unhappy with the fact that the spoon has been in contact with the unsanitary surface. Frequently, many users simply compromise and reuse the spoon. Other users may rinse the spoon or wipe the spoon in an attempt to partially cleanse the contaminated spoon surface. However, in such an example, the user would desire to have a spoon that can be stored in a manner that would avoid contamination due to the nonsterile surface.

Some users find themselves with a particular need or desire to practice food handling with a stronger than usual emphasis on hygiene and cleanliness. A specific example of this occurs when feeding a baby from baby food jars. There is often a strong desire on the part of new parents to practice good hygiene with the baby; however, unfortunately the circumstances surrounding such a feeding do not lend themselves to ultra clean food handling. There are distractions. Kitchen surfaces are contaminated by family activities in the area. As a result the parent may feel some pang of conscience if he or she lays a used spoon on such a kitchen surface. The parent would prefer to have some option of keeping the spoon in a more sanitary position.

While the above example has been explained with reference to a spoon, similar shortcomings also exist with respect to other utensils such as knives and forks. Further, these principles will extend to other common utensils such as tongs, spatulas, servers, whisks, and brushes.

Currently there are various types of stands, holders, clips, and rests that are made to be placed on an unsanitary surface or affixed to the edge of a container, upon which a utensil can be momentarily deposited. See, for example, U.S. Pat. No. 3,931,668, U.S. Pat. No. 1,483,833, U.S. Pat. No. 5,518,211, and U.S. Pat. No. 5,730,405. These items are generally intended for separate cleaning by dishwasher or a similar method. However, because these items must be retrieved when needed and require additional washing, they are unsatisfactory for people that value convenience.

There are also utensils conceived such that a hook feature is affixed to the backside of the functional end of a utensil. Published Patent Application No. 0185177. Said hook maintains the utensil in a vertical position at the edge of a generally vertically extending wall. While this allows for convenience of retrieval during cooking and prevents excess dripping that occurs during utensil movement, this design is insufficient to prevent contamination of the distal functional portion of the utensil during eating or serving, as the rim of the eating or serving container is potentially the least sanitary. It is also significant that such a design causes the hook portion to come into contact with the food or liquid during standard use of the functional end of the utensil. Placement of the hook on the rim of a container transfers the food or liquid to the rim and creates unnecessary mess. Additionally, due to placement of the hook on the functional end of the utensil, standard use of the utensil will cause contact between the hook feature and the mouth, likely including the teeth and tongue, of the user. Users will find this design unpleasant and unappealing for eating as the hook would of necessity be inserted into the user's mouth.

Further, U.S. Pat. No. 3,004,341 illustrates a kind of hook stamped from the thin metal stem of a spatula. However, the structure disclosed in this patent is not suitable for use with typical eating utensils such as spoons, knives, and forks. Such a kind of hook can only be used with relatively thin stems where a punch out manufacturing process can be used. Further, by virtue of the punch out process, the hook must necessarily be thinner than the width of the stem. Clearly the illustrated design in this patent could not be fit into the relatively small mouth of a baby food jar. Thus in spite of the aforementioned prior art, there remains a need for a means to use an eating utensil in a hygienic manner.

Hence there has been identified a need to provide an improved utensil design that provides for sanitary and convenient use during eating and serving. For example, it is desired that a utensil has a means for temporary deposit in a sanitary location; it is further desired that a utensil has improved hook placement, allowing the functional end to remain within the appropriate container and avoid contact of the functional portion with the rim; additionally, it would be desired that an improved utensil will have a hook that will position the handle in a vertical manner that is convenient for the user to grasp. The present invention addresses one or more of these long felt but unmet needs.

### SUMMARY OF THE INVENTION

In one embodiment, and by way of example only, there is provided a utensil with an integral clip device for securing the utensil to the top portion of a generally vertically extending wall defining an inner face and an outer face. The utensil comprises a proximal handle portion, a distal efficient portion, and an intermediate structural portion having a back or underneath portion defining a first surface and a hook defining a second surface extending generally parallel to said first surface and proximate thereto, whereby the utensil can be secured to the wall at the intermediate level, with the handle portion extending generally upward, by engaging the wall between the first surface and the second surface.

In a further embodiment, also by way of example only, there is provided a hook formed from the material that would otherwise comprise the unused portion of the stem, wherein the stem comprises a void area where the hook has been formed from the stem. In this embodiment, the combination of utensil and hook assembly is formed from a continuous allotment of material, allowing for a variation in manufacturing process.

In a further embodiment, and by way of example only, there is provided a utensil with hook assembly wherein the hook assembly is a separate piece, comprised of the same or similar material, attached to the stem during manufacturing. The hook assembly consists of a lateral portion and a clipping portion separated by a joint or a bend in the material. The lateral portion of the hook assembly is affixed to the stem of the utensil. The clipping portion extends either parallel to the stem or in a substantially linear position such that the clipping piece forms an angle with the stem. Clipping portion may also define a free end that cooperates with said first surface to define a tapering inlet.

In a further embodiment, and by way of example only, there is provided a utensil wherein the hook is positioned vertically on the stem such that the functional end of the utensil rests at a specific desired depth as measured relative to the bottom of a particular container.

In still a further embodiment, and still by way of example only, there is provided a utensil with hook assembly wherein said hook assembly has a transversal groove in inner surface near the lateral portion to provide a void for resting an outwardly extending lip that exists on some containers. This transversal groove preserves contact between the inner surface of the clipping portion and the outer surface of the container wall. The lower edge of said groove is beveled to allow the utensil to slip over the lip and enable convenient retrieval.

Other independent features and advantages of the hygienic utensil will become apparent from the following detailed description, taken in conjunction with the accompanying drawings which illustrate, by way of example, the principles of the invention.

### BRIEF DESCRIPTION OF THE DRAWINGS

FIG. 1 is a top view of a hygienic spoon, according to an embodiment of the present invention;

FIG. 2 is a side view of a hygienic spoon, according to an embodiment of the present invention;

FIG. 3 is a bottom view of a hygienic spoon, according to an embodiment of the present invention;

FIG. 4 is a perspective view of a hygienic spoon, according to an embodiment of the present invention, disposed in a drinking mug; and

FIG. 5 is a further perspective view of a hygienic spoon, according to an embodiment of the present invention, disposed in a bowl.

FIG. 6 is a more detailed side view of a hygienic spoon, according to an embodiment of the present invention.

FIG. 7 is a cross-sectional view of a hygienic spoon, according to an embodiment of the present invention, disposed on the wall of a container.

FIG. 8 is a cross-sectional view of a hygienic spoon, according to an embodiment of the present invention, wherein the hook assembly comprises a transversal groove, disposed on the wall of a container with a lip.

FIG. 9 is a bottom view of a hygienic spoon, according to an embodiment of the present invention, wherein the hook is created from the material of the stem, leaving a void area within the stem.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, the same reference numbers will be used throughout the drawings to refer to the same or like parts.

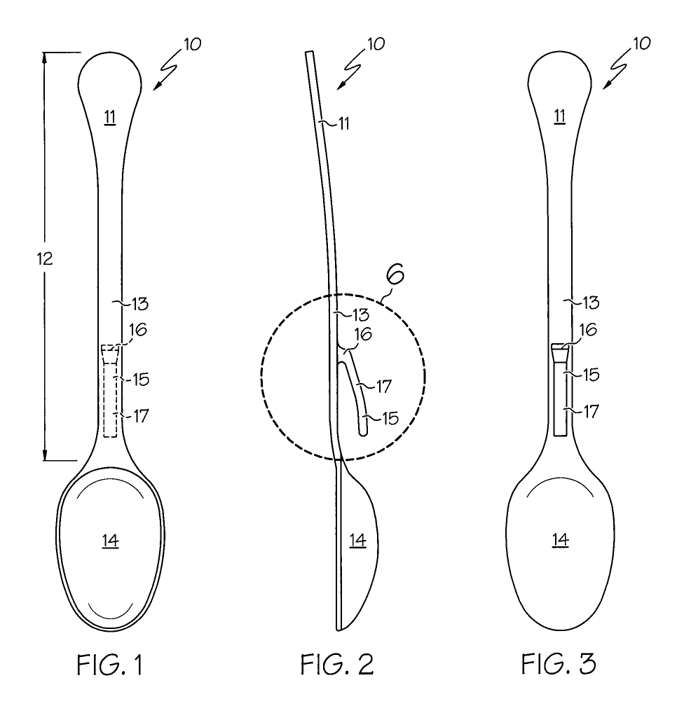

Referring initially to FIGS. 1, 2, and 3 there is shown a hygienic utensil, according to a preferred embodiment of the present invention. Utensil 10 in the illustrated embodiment takes the shape of a spoon. The hygienic utensil 10 includes a stem 12, hook assembly 15, and bowl 14. Stem 12 further comprises handle 11 and neck 13. Neck 13 and handle 11 each comprise approximately half of stem 12. Stem 12 can be characterized as having a length, width, and thickness. Width of stem 12 ranges from approximately ⅛ inch to approximately 1 inch, more preferably approximately ¼ inch to approximately ½ inch. Width of hook assembly 15 varies from approximately ⅛ inch to approximately 1 inch, more preferably approximately ¼ inch to approximately ½ inch. According to a preferred embodiment of the present invention, width of hook assembly 15 is less than width of stem 12. Hook assembly 15 is approximately ⅙ to ⅓ the length of stem 12. Hook assembly 15 is affixed to neck 13. Preferably hook assembly 15 is oriented with respect to bowl 14 so that hook assembly 15 extends from stem 12 in the same direction as the closed side of bowl 14 and opposite the side of stem 12 in which the food-holding portion of bowl 14 is directed.

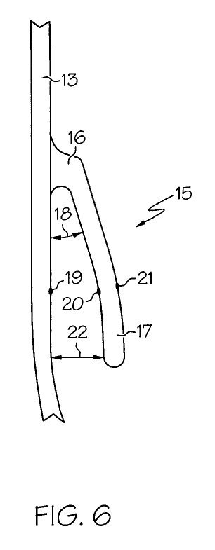

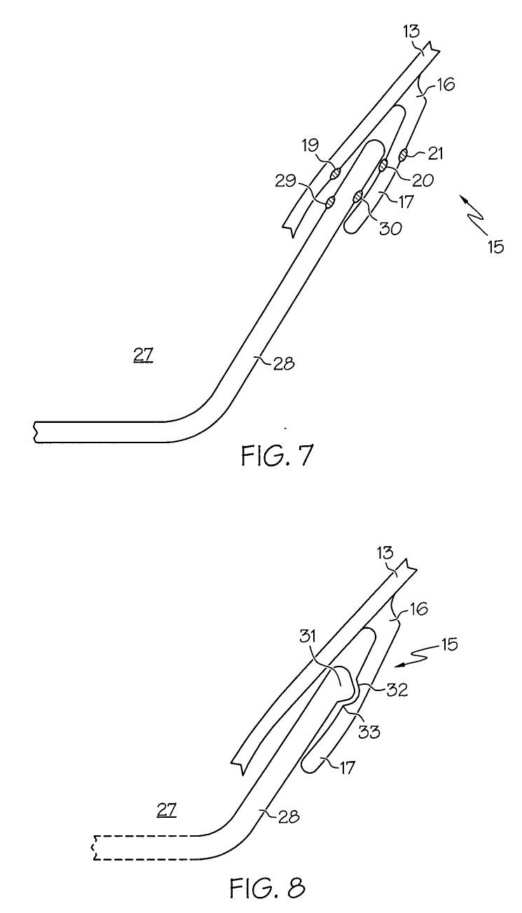

As indicated in FIGS. 6 and 7, neck 13 of stem 12 has a backside comprising surface one 19 for engaging an inner surface 29 of wall 28 of container 27. Hook assembly 15 comprises material extending from neck 13. Hook assembly 15 has surface two 20 and surface three 21. Surface two 20 of hook assembly 15 cooperates with surface one 19 at a distance 22, at the widest point, to engage the edge of container 27. Distance 22 between stem 12 and clipping portion 17 ranges anywhere from approximately ⅛ inch to approximately 1 inch, more preferably approximately ¼ inch to approximately ½ inch.

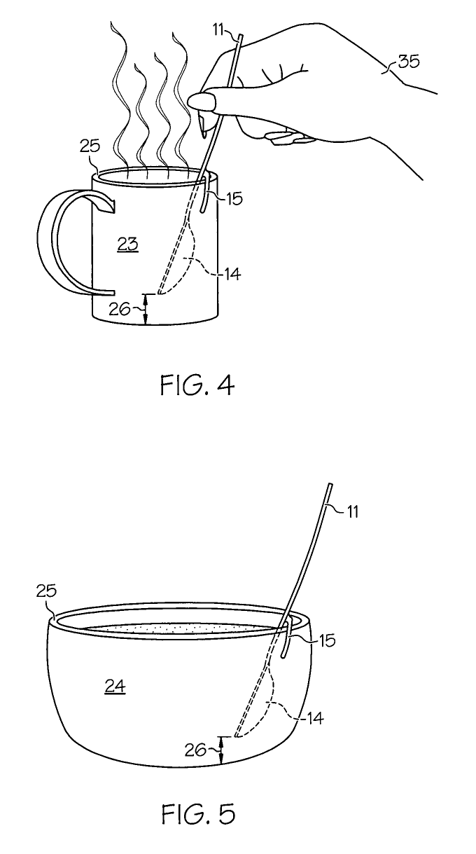

Further, utensil 10 can be characterized as having a center of gravity. In the embodiment of FIGS. 4 and 5, the manner in which utensil 10 with hook assembly 15 rests on the rim 25 of containers 23 and 24 depends on the center of gravity of utensil 10. Center of gravity can be located above, below or approximately equivalent to the point at which hook assembly 15 is affixed to neck 13 of stem 12. Preferably hook assembly 15 is positioned so that the overall center of gravity is below the point at which hook assembly touches stem 12.

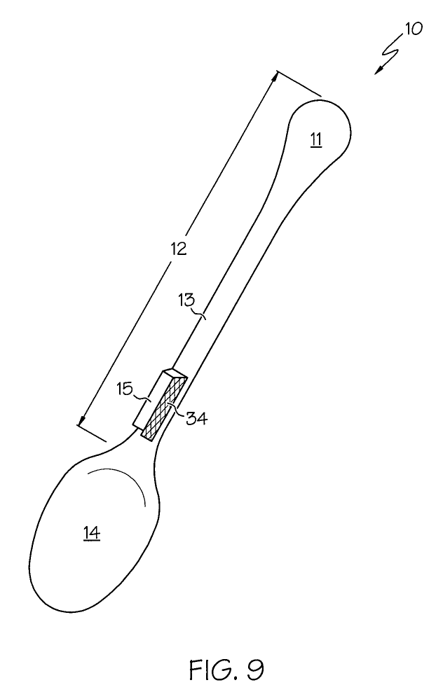

In FIG. 9, hook assembly 15 is formed from material otherwise comprising neck 13 leaving void area 34 where surface one 19 exists in the embodiment set forth in FIG. 6. In this embodiment utensil 10 and hook assembly 15 are created from a continuous allocation of material. Such embodiment requires that the width of neck 13 is greater than the width of hook assembly 15 by a minimum of approximately ⅛″.

As best represented in FIG. 2, 4, and 5, hook assembly 15 consists of a separate piece, preferably made from the same material, affixed to neck 13. In this embodiment, hook assembly 15 consists of lateral portion 16 and clipping portion 17. Lateral portion 16 is approximately 1/16″ to 5/16″ in length. Clipping portion 17 is approximately ⅙ to ⅓ the length of stem 12 and either extends parallel to stem 12 or forms angle 18 with stem 12. Said angle 18 between stem 12 and clipping portion 17 ranges from 1° to 45°, most preferably in the range of 10° to 25°.

As best represented in FIGS. 4 and 5, hook assembly 15 can be positioned vertically on stem 12 such that bowl 14 rests a distance 26 proximate to the bottom of mug 23 or bowl 24. When used with baby food jars, it is preferred so position hook assembly 15 so that the bowl touches or rests proximate to the bottom of the jar. It is intended that placement of bowl 14 toward the bottom of the baby food jar will place that portion of the spoon in the most desirable possible position (near the bottom of the jar and away from the opened top) for purposes of hygiene. Further, it will be appreciated that baby food jars have a rim that includes a threaded portion where the lid of the baby food jar has been removed, unlike a bowl or mug which more typically has a generally smooth rim surface. Thus, with respect to those utensils, such as spoons, adapted for use with baby food jars, the space 22 between hook assembly 15 and stem 12 is such that the space 22 allows the rim of the baby food jar to pass within the resting area of the hook assembly 12 so that the spoon can securely rest on the baby food jar rim. The overall length of the hook assembly 12 is also adapted so as to provide that the spoon rests in a secure manner on the baby food jar.

An additional embodiment, as represented in FIG. 8, comprises utensil 10 with hook assembly 15 where clipping portion 17 has transversal groove 32 for improved contact with container 27 containing outwardly extending lip 31. Beveled lower edge 33 of transversal groove 32 allows utensil 10 to slide conveniently over lip 31.

Utensil 10 with hook assembly 15 can be fabricated from a variety of materials including, but not limited to, plastics, composites, metals, glass and wood. Due to the nature of the preferred embodiment, many types of thin and durable material are adequate however certain uses will call for more specific material properties. As an example, convenience may require that a dishwasher-safe material, such as polypropylene is used.

Utensil 10 with hook assembly 15 can be manufactured using a variety of methods including, but not limited to, injection molding, thermoforming, casting, forging, flow forming, rolling, and extrusion. The appropriate method of manufacture is to be determined based on the material selected. Where two distinct pieces need to be affixed during manufacture, likely methods include, but are not limited to, stamping, soldering, welding and melt forming.

Use of the preferred embodiment of the invention is illustrated in FIG. 5. Utensil 10 will preferably be employed by user 35 in the standard fashion, by eating or serving. User 35 then places hook assembly 15 over the rim 25 of container 23 such that surface one 19 and surface two 20 engage the inner and outer surfaces that comprise the wall of container 23, respectively. Utensil 10 will remain in a generally vertical position for an indefinite period of time, or until user 35 removes utensil 10 by grasping handle 11 and lifting gently upward, a distance roughly equivalent to the length of clipping portion 17. Storage of utensil 10 by the placement of hook assembly 15 on rim 25 of container 27 is performed conveniently without requiring any device separate from the integral utensil. Thus, it is easy to appreciate that the above described embodiments according to the present invention provide an effective solution for preventing contamination of utensil 10 by preventing contact with unsanitary surfaces.

In one preferred embodiment, a utensil, such as a spoon is a substantially solid utensil, meaning that the utensil does not have present any holes, gaps, apertures, or the like in the stem. Thus, a substantially solid spoon or utensil would not have a hook punched out of the stem itself. Also, in a preferred embodiment, the hook assembly is a substantially rigid assembly. A substantially rigid assembly means that the hook itself has relatively little flexibility. A substantially rigid hook achieves its clipping or hanging ability by gravity and by close positioning of the rim within the catching area of the hook assembly; a substantially rigid hook assembly does not achieve its clipping or hanging ability by tensioning or biasing the hook against the rim. In a further preferred embodiment, the utensil comprises an eating utensil. The term eating utensil here means a utensil that is designed to assist a user in eating food; i.e., the utensil carries food to the user's mouth. An eating utensil is further designed such that a portion of the utensil, the bowl in the case of a spoon, is designed to enter the user's mouth. An eating utensil does not have a hook positioned so that the hook would enter the user's mouth. Further, the hook assembly is positioned so that the hook assembly would not interfere with the user grasping the utensil by hand. An eating utensil does not include serving or cooking utensils such as spatulas, which are not intended to be placed in the user's mouth.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. A spoon for hygienic positioning on the rim of a baby food jar, the spoon comprising:
a substantially solid stem characterized by a width;
a bowl affixed to the stem;
a substantially inflexible hook affixed to the stem, wherein the hook is characterized by a width substantially equal to the width of the stem;
wherein the hook is disposed so as to define a gap between the stem and the hook such that the rim of the baby food jar fits within the gap;
wherein the stem, bowl, and hook define a center of gravity; and
wherein the hook is positioned at a point above the center of gravity.

2. The spoon according to claim 1 wherein the stem, bowl, and hook comprise a polymer material.

3. The spoon according to claim 1 wherein the width of the stem and the width of the hook are between approximately one eighth inch and approximately one half inch.

4. The spoon according to claim 1 wherein the hook further defines at least one approximately planar surface which depends from the stem so as to define an angle with the stem of between approximately 5 and approximately 35 degrees.

5. The spoon according to claim 1 wherein the gap defined by the stem and the hook is between approximately one eighth and approximately one quarter inch.

6. An eating utensil for hygienic use with a container having a rim, the utensil comprising:
a substantially solid stem characterized by a width;
a substantially rigid hook affixed to the stem; and
wherein the hook defines an offset from the stem such that the rim of the container fits within the offset.

7. The utensil according to claim 6 wherein the hook has a width less than the width of the stem.

8. The utensil according to claim 6 wherein the utensil is further characterized by a center of gravity, and wherein the center of gravity is positioned below the hook.

9. The utensil according to claim 6 wherein the utensil is further characterized by a center of gravity, and wherein the center of gravity is positioned at a point generally equal to the position of the hook.

10. The utensil according to claim 6 wherein the hook further comprises a lateral portion positioned substantially planar to the stem and a clipping portion attached to the lateral portion wherein the clipping portion is positioned substantially parallel to the stem.

11. The utensil according to claim 10 wherein the clipping piece is of a length that is at least one sixth the length of the stem.

12. The utensil according to claim 6 wherein the hook comprises a single clipping piece that extends from the stem in a substantially linear position such that the clipping piece forms an angle with the stem.

13. The utensil according to claim 12 wherein the clipping piece is of a length that is at least one sixth the length of the stem.

14. The utensil according to claim 6 wherein the utensil further comprises a spoon portion.

15. The utensil according to claim 6 wherein the utensil further comprises a knife portion.

16. The utensil according to claim 6 wherein the utensil further comprises a fork portion.

17. The utensil according to claim 1 wherein the utensil further comprises a food gathering portion connected to the stem, and wherein the food gathering portion is selected from the group consisting of a spoon, a knife, and a fork.

18. A method for securing a spoon having a bowl and a hook to a baby food jar having an interior region and also having a lip, the method comprising the step of:
positioning the spoon so that the bowl is disposed within the interior region of the baby food jar;
placing the spoon against the baby food jar such that the hook engages the lip of the baby food jar.

19. The method according to claim 18 wherein engaging the hook further comprises positioning a transversal groove disposed on the hook such that said lip rests within a recess of the hook.

20. The method according to claim 18 wherein the baby food jar comprises a bottom and further comprising engaging the hook on the lip so that the bottom of the spoon rests proximate the bottom of the baby food jar.
